(19) United States
(12) Patent Application Publication
(10) Pub. No.: US 2024/0072454 A1
(43) Pub. Date: Feb. 29, 2024

(54) SHARED APERTURE MULTI-BAND METASURFACE ELECTRONICALLY SCANNED ANTENNA (ESA)

(71) Applicant: Kymeta Corporation, Redmond, WA (US)

(72) Inventors: Seyed Mohamad Amin Momeni Hasan Abadi, Redmond, WA (US); Mohammad Ranjbamikkhah, Redmond, WA (US); Mohsen Sazegar, Krikland, WA (US)

(21) Appl. No.: 18/238,305

(22) Filed: Aug. 25, 2023

Related U.S. Application Data
(60) Provisional application No. 63/401,825, filed on Aug. 29, 2022.

(51) Int. Cl. H01Q 21/00; H01Q 1/24; H01Q 21/28

(52) U.S. Cl. CPC H01Q 21/0056; H01Q 1/241; H01Q 21/28

(57) ABSTRACT

Shared aperture multi-band antennas (e.g., metasurface electronically scanned antennas (ESAs), etc.) are described. In some embodiments, an antenna includes an aperture having a plurality of multi-band radio-frequency (RF) radiating antenna elements, wherein each antenna element of the plurality of multi-band RF radiating antenna elements is configurable to operate at any of multiple bands. In some embodiments, the antenna also includes a controller coupled to the plurality of antenna elements to dynamically configure said each antenna element of the plurality of antenna elements to operate at each of the multiple bands at different times.

### RELATED APPLICATION

The present application is a non-provisional application of and claims the benefit of U.S. Provisional Patent Application No. 63/401,825, filed Aug. 29, 2022, and entitled “Shared Aperture Ku- and Ka-Band Metasurface ESA”, which is incorporated by reference in its entirety.

### FIELD OF THE DISCLOSURE

Embodiments disclosed herein are related to wireless communication; more particularly, embodiments disclosed herein relate to a multi-band metasurface ESA, such as can be used, for example, in a satellite terminal.

### BACKGROUND

Metasurface antennas have recently emerged as a new technology for generating steered, directive beams from a lightweight, low-cost, and planar physical platform. Such metasurface antennas have been recently used in a number of applications, such as, for example, satellite communication. These antennas can have radio-frequency (RF) radiating antenna elements and are electrically scanned to perform transmit (Tx) and receive (Rx) operations.

Satellite antennas used in satellite terminals are typically designed for operation at one frequency band. Well-known examples of some such frequency bands include Ka and Ku frequency bands. Metasurface antennas and antennas with traditional phased arrays antennas have been designed to operate at either the Ka and Ku bands, as well as other frequency bands. However, if there is a need to communicate at multiple bands (e.g., both Ka and Ku bands), then solutions are limited. For example, to support communication at both multiple bands using traditional phased arrays, multiple flat panel apertures designed to operate at different frequency bands would have to be configured side-by-side in order to support operation using multiple bands.

### SUMMARY

Shared aperture multi-band antennas (e.g., metasurface electronically scanned antennas (ESAs), etc.) are described. In some embodiments, an antenna includes an aperture having a plurality of multi-band radio-frequency (RF) radiating antenna elements, wherein each antenna element of the plurality of multi-band RF radiating antenna elements is configurable to operate at any of multiple bands. In some embodiments, the antenna also includes a controller coupled to the plurality of antenna elements to dynamically configure said each antenna element of the plurality of antenna elements to operate at each of the multiple bands at different times.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas described herein.

FIG. 3A illustrates some embodiments of a Ka/Ku quadband metasurface.

FIG. 3B illustrates some embodiments of a metasurface with dual-band radiating elements.

FIG. 4 illustrates some embodiments of dual-band radiating elements utilizing first and second resonances of the slot to achieve dual-band operation.

FIG. 5A illustrates some embodiment of dual-band radiating elements with a die integrating both Ka and Ku tunable components for half-duplex operation.

FIG. 5B illustrates some embodiment of dual-band radiating elements with a die integrating both Ka and Ku tunable components for full-duplex operation.

FIGS. 6A and 6B illustrate some embodiments of dual-band radiating elements with two integrated circuit dies for (A) half-duplex and (B) full-duplex operation, respectively.

FIG. 7 illustrates some embodiments of a process for controlling an RF radiating antenna element.

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Embodiments described herein relate to metasurface electronically steered antennas (ESAs) that have a single aperture with antenna elements that can be configured for use at multiple frequency bands. That is, a single aperture integrates antenna elements that are configurable to operate at one of multiple frequency bands at any one time. In some embodiments, the antenna elements are radio-frequency (RF) radiating antenna elements that operate at multiple bands (e.g., Ku and Ka bands). The multiple bands can be transmit (Tx) and receive (Rx) bands. In some embodiments, multiple receive (Rx) and transmit (Tx) bands include Ka and Ku receive (Rx) and transmit (Tx) bands.

Shared-aperture multi-band mobile user satellite terminals that operate at both Ku/Ka bands are highly desired for both commercial and government applications. Combining Ku/Ka Rx and Tx bands into a single physical aperture is currently not feasible with traditional phased array architectures. This is due to at least two key challenges: (1) space available for beamforming ICs is limited due to array density, and also (2) power requirements cannot meet size, weight, power, and cost (SWaP-C) requirements for mobile user terminals. A single shared aperture solution will have a significant advantage in terms of cost and size.

The following disclosure discusses examples of antenna apparatus embodiments followed by details of shared aperture embodiments.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture having the one or more arrays of antenna elements is comprised of multiple segments that are coupled together. In some embodiments, when coupled together, the combination of the segments form groups of antenna elements (e.g., closed concentric rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

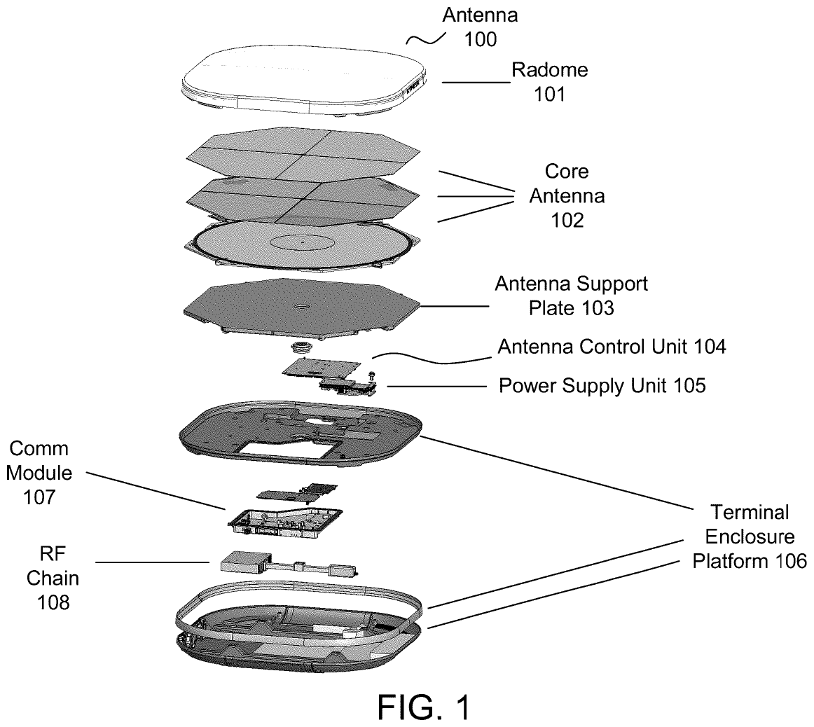

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

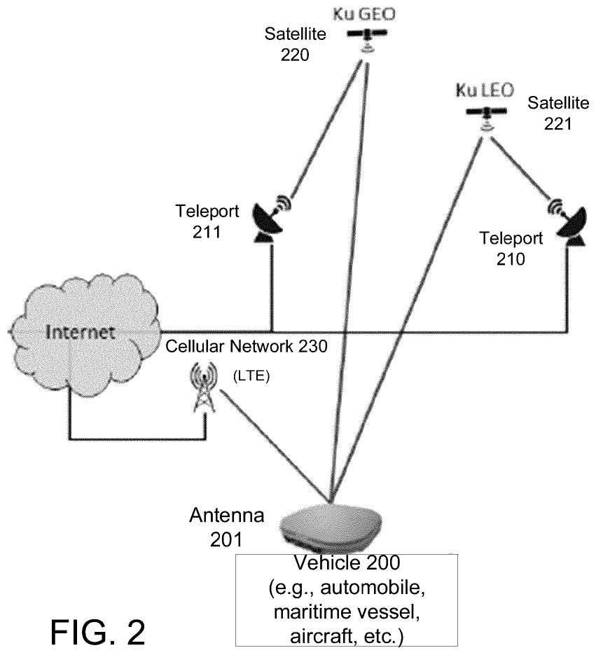

FIG. 2 illustrates an example of a communication system that includes one or more antennas described herein. Referring to FIG. 2, vehicle 200 includes an antenna 201. In some embodiments, antenna 201 comprises antenna 100 of FIG. 1.

In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause, or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communicate with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections.

In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Embodiments of Antennas with Shared Apertures

Antenna embodiments are disclosed here that integrate multiple receive (Rx) and transmit (Tx) frequency bands (e.g., Ka/Ku Rx and Ka/Ku Tx bands) into a shared aperture metasurface ESA. In some embodiments, the integration relies on two concepts: (1) interleaving sub-arrays of radiating antenna elements in a single metasurface to achieve shared aperture operation, and (2) loading radiating elements with integrated varactor circuits (or other tunable components) to control the resonances and to allow multi-band operation of radiating antenna elements.

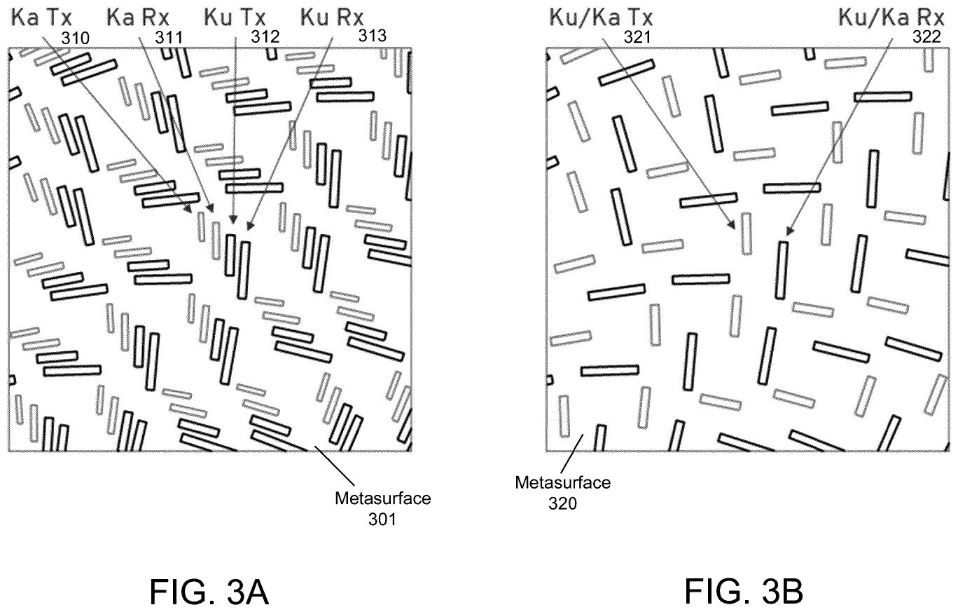

FIG. 3A shows some embodiments of a Ku/Ka dual-band metasurface where the shared aperture capability is achieved by interleaving subarrays of Ku/Ka (dual-band) Rx and Tx radiating antenna elements. Referring to FIG. 3A, metasurface 301 includes groups of RF radiating antenna elements. In some embodiments, each group of RF radiating antenna elements includes a Ka Tx radiating antenna element, such as Ka Tx radiating element 310, a Ka Rx radiating antenna element, such as Ka Rx radiating element 311, a Ku Tx radiating antenna element, such as Ku Tx radiating element 312, and a Ku Rx radiating antenna element, such as Ku Rx radiating element 313.

The implementation of a Ku/Ka dual-band metasurface according to FIG. 3A can have challenges due to the density requirements of Ka band and large frequency separation between Ka and Ku bands. To be more specific, the Ka aperture may require a metasurface with a high density that may not allow for placing and fitting Ku radiating elements with required efficiency. For example, in some implementations, the spacing between Ka band elements is 0.08 in while the spacing between Ka band elements is 0.16 in, or twice as much. Thus, in some embodiments, an aperture combining these two bands uses the smaller of these distances, which is not efficient. Furthermore, the slot (iris) sizes for different bands (e.g., Ku band slots are much larger than Ku band slots) also makes integrating them together difficult. Moreover, when adding several sub-arrays into a single aperture, fitting the integrated circuits (ICs) and/or circuitry for driving those elements into the aperture is also considered and is difficult with the size of the elements and the distances between them.

To mitigate these challenges, in some embodiments, the antenna aperture includes and uses multi-band radiating antenna elements that can be dynamically configured to operate at one of multiple frequency bands. In some embodiments, the antenna aperture includes and uses dual-band radiating antenna elements that operate at more than one or multiple bands, for example, in some embodiments, at two, or dual, frequency bands (e.g., both Ku and Ka bands). FIG. 3B illustrates some embodiments of an implementation of shared aperture metasurface ESA where the Ku/Ka bands share the same Rx and Tx radiating elements. Referring to FIG. 3B, metasurface 320 includes many RF radiating antenna elements, and each of the RF antenna elements can be configured to operate in either of the Ku or Ka bands. For example, Ku/Ka Tx RF radiating antenna element 321 can be configured at any time to operate either at the Ku band or Ka band for Tx operation, while Ku/Ka Rx RF radiating antenna element 322 can be configured at any time to operate either at the Ku band or Ka band for Rx operation. In the following description, several embodiments of dual-band radiating antenna elements are described.

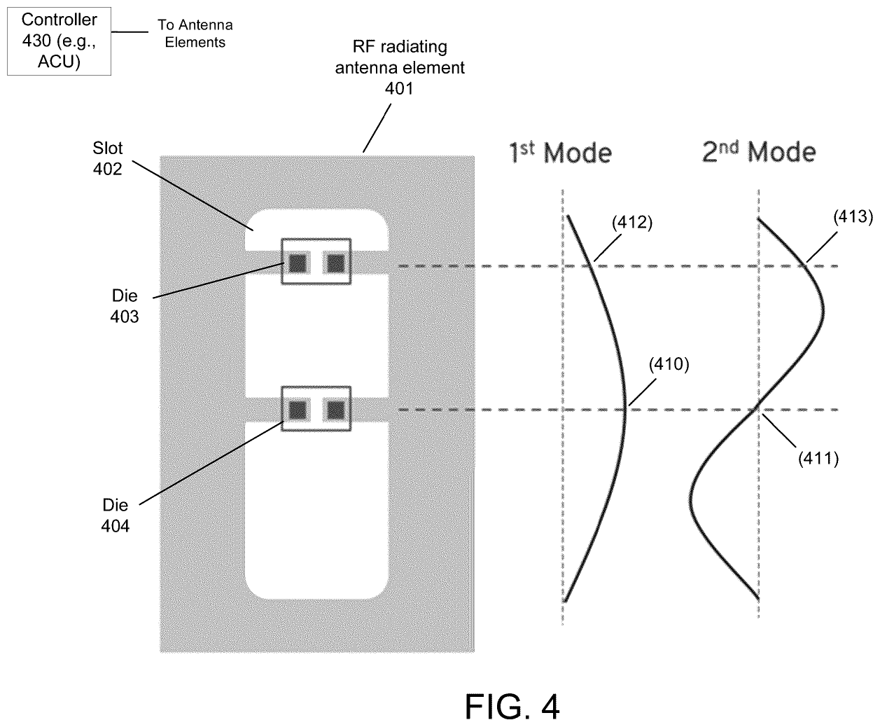

FIG. 4 shows some embodiments of a dual-band radiating antenna element. Referring to FIG. 4, in some embodiments, RF radiating antenna element 401 comprises slot (iris) 402 that is loaded with two dies 403 and 404. In some embodiments, dies 403 and 404 are coupled across the width of the slot to pads on each side of slot 402. In some embodiments, dies 403 and 404 are integrated circuits (ICs) and may include varactor diodes (or other tunable devices) and other additional components (e.g., capacitors, other components described in more detail below). The tunable device acts as described above and its operation is well-known to those skilled in the art.

The dual band operation is achieved by using the first and second resonances of each antenna element, such as RF radiating antenna element 401, and independent control of each resonance is enabled by choosing the location of the tunable component. The resonances associated with dies 403 and 404 are shown as 2^{nd} Mode and 1^{st} Mode, respectively, in FIG. 4.

More specifically, the operation of radiating antenna elements, such as radiating antenna element 401, can be explained by the voltage distribution of the first and second resonances of slot 402. At the center of slot 402 where die 404 is coupled across its width, the voltage is maximum (410) in the first resonance while it is zero (411) at the second resonance. This means that by loading the tunable component in die 404 at the center, the first resonance can be tuned without impacting the second resonance (since it is at zero at the point). On the other hand, if the tunable component is placed at the edge of antenna element 401, such as the tunable component in die 403, it mostly affects the second resonance. In this case, the impact on first resonance is small due to the smaller electric distribution. As shown in FIG. 4, the voltage in the first resonance (412) is much smaller than the voltage in the second resonance (413), and therefore the influence of die 404 is much less than die 403 in the second mode.

In some embodiments, the two dies are placed in positions where the mode of the other one is a zero, or null. Therefore, in such embodiments, placements of the dies may not be exactly at the center or at the very edge, but are placed based on where they produce nulls or have very little influence on the resonance for the antenna element at the other band. Note also in some embodiments, the die positioned near the edge is placed as close, proximate, or adjacent to the edge as possible without creating a short circuit across slot 402.

In some embodiments, the position of the dies as described above, with one at the center and one near the edge, enables independent control of the two modes. In some embodiments, the die near the edge is located at a distance from the edge of the end of the slot that is approximately one-tenth (10%) the length of the slot. For example, if the length of the slot is 2500 microns, the die can be located 200-250 microns from the edge at the end of the slot. In some other embodiments, the position of the dies may not be in the center and near the edge but are still offset with respect to each other. Such an arrangement may impact their independent control as they may tune together. Note that the placement of the dies for Tx and Rx antenna elements can be different in some embodiments.

In some embodiments, control of the resonances of the antenna elements is performed using controller 430. In some embodiments, controller 430 is, or is part of, the antenna control unit (ACU) of the satellite antenna as described above and/or the terminal of which it is part. Such a controller can be included to control other embodiments of antenna elements described herein.

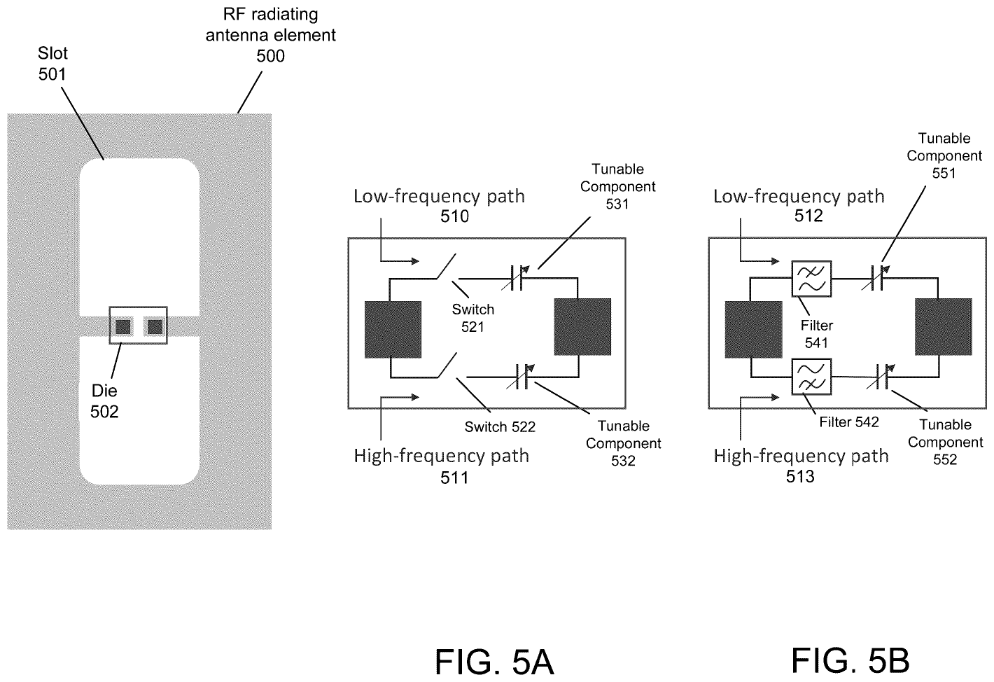

FIGS. 5A and 5B show some other embodiments of a dual-band radiating antenna element. Referring to FIGS. 5A and 5B, dual-band radiating antenna element 500 comprises a slot 501 that is loaded with a die 502. Die 502 is coupled across the width of slot 501 to pads on both sides of slot 501. In some embodiments, die 502 is an IC that includes a tuning element. In some embodiments, die 502 also comprises two signal paths, one for low frequency operation of dual-band radiating antenna element 500, referred to herein as the low frequency path, and one for high frequency operation of dual-band radiating antenna element 500, referred to herein as the high frequency path. In some embodiments, the low frequency path is used and corresponds to the Ku frequency band, while the high frequency path is used and corresponds to the Ka frequency band.

As shown in FIG. 5A, in some embodiments of a half-duplex design, each path comprises a switch (e.g., MEMS switch, etc.) and a tunable component (e.g., varactor diode, MEMS-based tunable capacitor, etc.). For example, low frequency path 510 includes switch 521 and a tuning component 531, while high frequency path 511 includes switch 522 and a tuning component 532. When operating antenna element 500 at the lower band (e.g., Ku band), switch 521 in low frequency path 510 is closed and switch 522 in high frequency path 511 is open, thereby causing high frequency path 511 in die 502 and its tuning component 532 to have no (or little) influence on operation of slot 501 during low frequency operation. When operating antenna element 500 at the higher frequency band (e.g., Ka band), switch 522 in high frequency path 511 is closed and switch 521 in low frequency path 510 is open, thereby causing low frequency path 510 in die 502, and its tuning component 531, to have no (or little) influence on operation of slot 501 during high frequency operation. In some embodiments, the opening and closing of switches is performed by the ACU, which is also controlling the tunable components.

As shown in FIG. 5B, in some embodiments of a full-duplex design, switches 521 and 522 are replaced with low-pass and high pass filters, with filter 541 at low frequency path 512 being a high pass filter and filter 542 at high frequency path 513 being a low pass filter. During operation, each path is in use if the frequency band of operation is in the passband of the filter. Filters 541 and 542 do not share the same pass band, so the pass band of filter 541 is within the top band of filter 542 and vice versa. If the band of operation is in the passband of filter 541, then the low frequency path is “closed”. Since the band of operation is in the stop band of filter 542, the high frequency path will be “open”. In some embodiments, the filter characteristics are selected to minimize loss and maximize isolation. In some embodiments, these filter characteristics include the order of the filter and the filter type. For higher isolation between the two bands, higher order filters can be used. As for filter types, there are many well-known filters (e.g., Butterworth, Chebyshev, Bessel, etc.) that may be used.

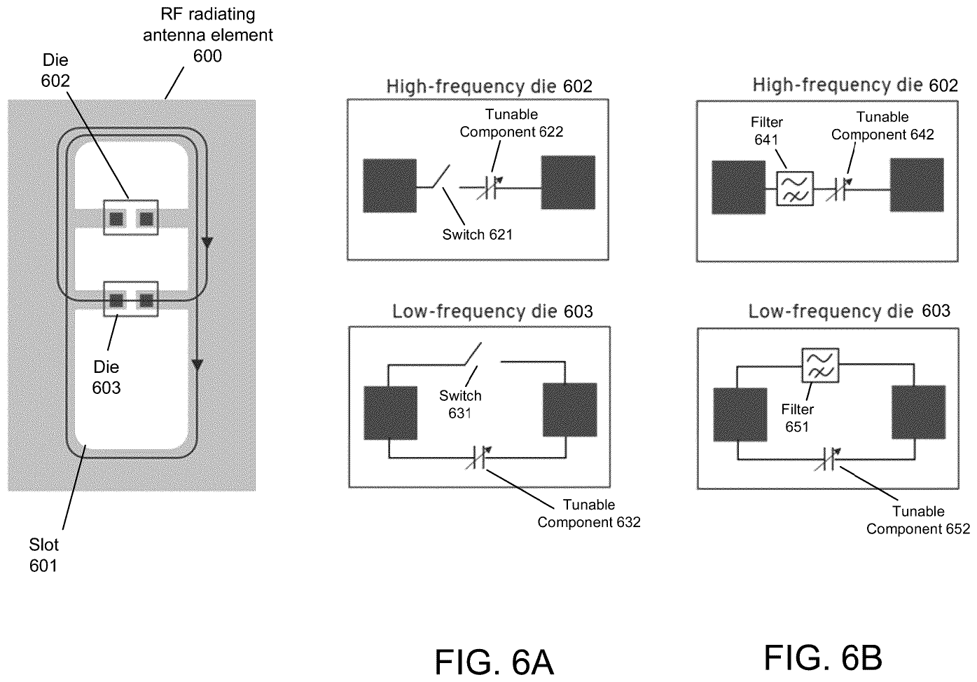

FIGS. 6A and 6B show some other embodiments of a dual-band radiating antenna element. Referring to FIGS. 6A and 6B, the dual-band radiating antenna element 600 comprises a slot 601 loaded with two dies 602 and 603. In some embodiments, each die provides an independent control for one of the bands. For example, where dual-band radiating antenna element 600 can be operated in Ku and Ka bands, one of dies 602 and 603 controls dual-band radiating antenna element 600 for Ku band operation, while the other of dies 602 and 603 controls dual-band radiating antenna element 600 for Ka band operation.

FIG. 6A illustrates some embodiments of low-frequency and high-frequency dies for a half-duplex operation mode. In this case, low frequency die 603 is placed at and coupled across the width of slot 601 at the center of slot 601 (or substantially near the center of slot 601) to pads on each side of slot 601, and high frequency die 602 is coupled across the width slot 601 to pads on each side of slot 601 and is placed with an offset with respect to placement of low frequency die 603. In some embodiments, low frequency die 603 comprises a tunable component 632 (e.g., a varactor diode, etc.) coupled in parallel with a switch 631, and high frequency die 602 comprises a tunable component 622 (e.g., a varactor diode, etc.) coupled in series with a switch 621.

When dual-band radiating antenna element 600 is operating at the low frequency band, both switches 621 and 631 are open. When both switches 621 and 631 are open, the tunable element 632 (e.g., a varactor) of low frequency die 603 at the center is operational but the other tunable element 622 will be open (as if nothing is positioned there). When dual-band radiating antenna element 600 is operating at the high frequency band, both switches 621 and 631 are closed, and slot 601 is short circuited at the center (as if there is no tunable element (e.g., varactor) there, so the effective size of the slot is cut in half. However, high frequency die 602 at the other location is connected. This is beneficial for this application since the Ka frequency bands are approximately twice the Ku frequency bands. In some embodiments, die 603 is placed at the center of slot 601 while die 602 is placed between the center and edge of slot 601 (e.g., ¼ of the slot length away from the edge of slot 601). Note that in some other embodiments, die 602 is placed at a distance from the end of slot 601 that is approximately one-tenth the length of slot 601. Other locations can be used as long as the influence of the die as to independently controlling resonances of slot 601 is minimal or null.

FIG. 6B illustrates a similar embodiment to that of FIG. 6A except for full-duplex operation. In this mode, switches 621 and 631 of dies 602 and 603, respectively, are replaced with high-pass filters. For example, in FIG. 6B, high frequency die 602 includes high-pass filter 641 in series with tunable component 642, while low frequency die 603 includes high-pass filter 651 coupled in parallel with tunable component 652. The high frequency band of interest (Ka) falls within the pass band of the high pass filter, and the low frequency band of interest (Ku) falls within the stop band of the filter. These filters could have similar characteristics. Therefore, if the signal is within the passband of the filters, high frequency die 602 is operational, and low frequency die 603 is short circuited; if the signal is within the stop band of the filters, low frequency die 603 is operational, and high frequency die 602 is open.

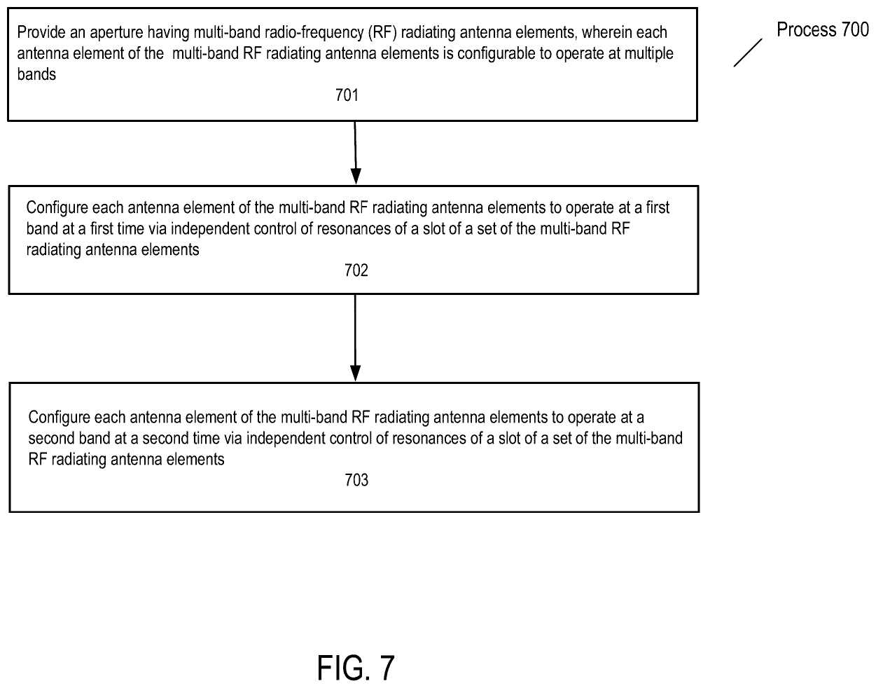

FIG. 7 illustrates some embodiments of a process for controlling an RF radiating antenna element. In some embodiments, such an RF radiating antenna element can comprise a multi-band antenna element. In some other embodiments, such an RF radiating antenna element can comprise a multi-band antenna element.

Referring to FIG. 7, the process begins by providing an aperture having multi-band radio-frequency (RF) radiating antenna elements (701). In some embodiments, each antenna element is configurable to operate at multiple frequency bands one at a time. In some embodiments, the multi-band RF radiating antenna elements are dual-band RF radiating antenna elements and can be configured to operate at either of the two bands. In some embodiments, the two bands comprise the Ka and Ku bands. Note that in some other embodiments, the antenna elements are configured to operate at other frequency bands.

Next, a set of one or more of the multi-band RF radiating antenna elements are configured to operate at a first band (e.g., Ka, Ku, etc.) at a first time by controlling resonances of a slot of each multi-band RF radiating antenna element in the set (702). This results in obtaining operation of the set of multi-band RF radiating antenna elements at the first band.

Subsequently, the set (or another set) of the multi-band RF radiating antenna elements are configured to operate at a second band at a second time by controlling resonances of a slot of each multi-band RF radiating antenna element in the set, where the first and second bands are different (703). This results in obtaining operation of the set of multi-band RF radiating antenna elements at the second band.

In some embodiments, the resonances of the antenna elements are controlled independently. For example, in the case that the antenna elements are dual-band RF radiating antenna elements, the slots have first and second resonances that are independently controlled to obtain operation of the plurality of multi-band RF radiating antenna elements at one of either first and second frequency bands.

There are a number of example embodiments described herein.

Example 1 is an antenna comprising: an aperture having a plurality of multi-band radio-frequency (RF) radiating antenna elements, wherein each antenna element of the plurality of multi-band RF radiating antenna elements is configurable to operate at any of multiple bands; and a controller coupled to the plurality of antenna elements to dynamically configure said each antenna element of the plurality of antenna elements to operate at each of the multiple bands at different times.

Example 2 is the antenna of example 1 that may optionally include that the multiple bands comprise two bands.

Example 3 is the antenna of example 2 that may optionally include that the two bands are Ku and Ka bands.

Example 4 is the antenna of example 2 that may optionally include that the two bands share the same receive (Rx) and transmit (Tx) radiating elements.

Example 5 is the antenna of example 1 that may optionally include that the plurality of multi-band RF radiating antenna elements comprises a first sub-array of multi-band RF radiating antenna elements for performing transmit (Tx) operations and a second sub-array of multi-band RF radiating antenna elements for performing receive (Rx) operations, and the first and second sub-arrays are interleaved across the aperture.

Example 6 is the antenna of example 1 that may optionally include that each RF radiating antenna element comprises a slot loaded with one or more tunable components.

Example 7 is the antenna of example 6 that may optionally include that at least one of the one or more tunable components comprises a varactor.

Example 8 is the antenna of example 6 that may optionally include that the slot is loaded with at least one integrated circuit die.

Example 9 is the antenna of example 6 that may optionally include that the controller is operable to independently control first and second resonances of the slot of each of the plurality of multi-band RF radiating antenna elements to obtain operation of the plurality of multi-band RF radiating antenna elements at each of the multiple bands.

Example 10 is the antenna of example 9 that may optionally include first and second dies containing first and second tunable components, respectively, of the one or more tunable components and coupled across a width of the slot at a central portion of the slot and at a location proximate to the edge of the slot without creating a short circuit, respectively, such that influence on frequency band operation associated with the first tunable component does not detrimentally affect frequency band operation associated with the second tunable component, and vice versa.

Example 11 is the antenna of example 9 that may optionally include that the first and second dies having two signal paths, with each signal path being associated with one of the multiple bands and wherein the controller selects use of one of the two signal paths according to which band of the multiple bands for which the slot is to be operating.

Example 12 is the antenna of example 11 that may optionally include that each of the two signal paths includes a switch, and wherein the controller is operable to close the switch of each of the two signal paths to configure the slot for operation with a band of the multiple bands that is associated with said each signal path.

Example 13 is the antenna of example 11 that may optionally include that the multiple bands include a first band and a second band, and further wherein first and second signal paths of the two signal paths includes a first filter having a passband for the first band and a second filter having a passband for the second band.

Example 14 is the antenna of example 9 that may optionally include first and second dies coupled across a width of the slot at a central portion of the slot and the second die being coupled across the width of the slot at a location offset from the first tunable component, respectively, wherein the first and second dies contain first and second tunable components, respectively, with two signal paths respectively, the first and second dies configured to independently control first and second frequency bands, respectively, of the multiple bands.

Example 15 is the antenna of example 6 that may optionally include that at least one of the one or more tunable components comprises a MEMS switch to change the electrical length of the slot.

Example 15 is an antenna comprising: an aperture having a plurality of dual-band radio-frequency (RF) radiating antenna elements, wherein each antenna element of the plurality of dual-band RF radiating antenna elements is configurable to operate at each of two bands, wherein the two bands share the same receive (Rx) and transmit (Tx) radiating elements and each RF radiating antenna element comprises a slot loaded with one or more tunable components; and a controller coupled to the plurality of antenna elements to dynamically configure said each antenna element of the plurality of antenna elements to operate at each of the dual bands at different times, wherein the controller is operable to independently control first and second resonances of the slot of each of the plurality of multi-band RF radiating antenna elements to obtain operation of the plurality of multi-band RF radiating antenna elements at each of the multiple bands.

Example 17 is the antenna of example 16 that may optionally include first and second dies containing first and second tunable components, respectively, of the one or more tunable components and coupled across a width of the slot at a central portion of the slot and at a location close to the edge of the slot without creating a short circuit, respectively, such that influence on frequency band operation associated with the first tunable component does not detrimentally affect frequency band operation associated with the second tunable component, and vice versa.

Example 18 is the antenna of example 17 that may optionally include that the first and second dies have two signal paths, with each signal path being associated with one of the multiple bands and wherein the controller selects use of one of the two signal paths according to which band of the multiple bands for which the slot is to be operating, and further wherein each of the two signal paths includes a switch, and wherein the controller is operable to close the switch of each of the two signal paths to configure the slot for operation with a band of the multiple bands that is associated with said each signal path.

Example 19 is the antenna of example 16 that may optionally include that the two bands are Ku and Ka bands.

Example 20 is a method comprising: configuring each antenna element of a plurality multi-band radio-frequency (RF) radiating antenna elements to operate at a first band at a first time; and configuring said each antenna element of a plurality multi-band radio-frequency (RF) radiating antenna elements to operate at a second band at a second time, wherein the first and second bands are different.

Example 21 is the method of example 19 that may optionally include independently controlling first and second resonances of a slot of each of the plurality of multi-band RF radiating antenna elements to obtain operation of the plurality of multi-band RF radiating antenna elements at each of the first and second bands.

All of the methods and tasks described herein, in some embodiments, may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. An antenna comprising:
an aperture having a plurality of multi-band radio-frequency (RF) radiating antenna elements, wherein each antenna element of the plurality of multi-band RF radiating antenna elements is configurable to operate at any of multiple bands; and
a controller coupled to the plurality of antenna elements to dynamically configure said each antenna element of the plurality of antenna elements to operate at each of the multiple bands at different times.

2. The antenna of claim 1 wherein the multiple bands comprise two bands.

3. The antenna of claim 2 wherein the two bands are Ku and Ka bands.

4. The antenna of claim 2 wherein the two bands share the same receive (Rx) and transmit (Tx) radiating elements.

5. The antenna of claim 1 wherein the plurality of multi-band RF radiating antenna elements comprises a first sub-array of multi-band RF radiating antenna elements for performing transmit (Tx) operations and a second sub-array of multi-band RF radiating antenna elements for performing receive (Rx) operations, and the first and second sub-arrays are interleaved across the aperture.

6. The antenna of claim 1 wherein each RF radiating antenna element comprises a slot loaded with one or more tunable components.

7. The antenna of claim 6 wherein at least one of the one or more tunable components comprises a varactor

8. The antenna of claim 6 wherein the slot is loaded with at least one integrated circuit die.

9. The antenna of claim 6 wherein the controller is operable to independently control first and second resonances of the slot of each of the plurality of multi-band RF radiating antenna elements to obtain operation of the plurality of multi-band RF radiating antenna elements at each of the multiple bands.

10. The antenna of claim 9 further comprising first and second dies containing first and second tunable components, respectively, of the one or more tunable components and coupled across a width of the slot at a central portion of the slot and at a location proximate to the edge of the slot without creating a short circuit, respectively, such that influence on frequency band operation associated with the first tunable component does not detrimentally affect frequency band operation associated with the second tunable component, and vice versa.

11. The antenna of claim 9 wherein the first and second dies having two signal paths, with each signal path being associated with one of the multiple bands and wherein the controller selects use of one of the two signal paths according to which band of the multiple bands for which the slot is to be operating.

12. The antenna of claim 11 wherein each of the two signal paths includes a switch, and wherein the controller is operable to close the switch of each of the two signal paths to configure the slot for operation with a band of the multiple bands that is associated with said each signal path.

13. The antenna of claim 11 wherein the multiple bands include a first band and a second band, and further wherein first and second signal paths of the two signal paths includes a first filter having a passband for the first band and a second filter having a passband for the second band.

14. The antenna aperture of claim 9 further comprising first and second dies coupled across a width of the slot at a central portion of the slot and the second die being coupled across the width of the slot at a location offset from the first tunable component, respectively,
wherein the first and second dies contain first and second tunable components, respectively, with two signal paths respectively, the first and second dies configured to independently control first and second frequency bands, respectively, of the multiple bands.

15. The antenna of claim 6 wherein at least one of the one or more tunable components comprises a MEMS switch to change the electrical length of the slot.

16. An antenna comprising:
an aperture having a plurality of dual-band radio-frequency (RF) radiating antenna elements, wherein each antenna element of the plurality of dual-band RF radiating antenna elements is configurable to operate at each of two bands, wherein the two bands share the same receive (Rx) and transmit (Tx) radiating elements and each RF radiating antenna element comprises a slot loaded with one or more tunable components; and
a controller coupled to the plurality of antenna elements to dynamically configure said each antenna element of the plurality of antenna elements to operate at each of the dual bands at different times, wherein the controller is operable to independently control first and second resonances of the slot of each of the plurality of multi-band RF radiating antenna elements to obtain operation of the plurality of multi-band RF radiating antenna elements at each of the multiple bands.

17. The antenna of claim 16 further comprising first and second dies containing first and second tunable components, respectively, of the one or more tunable components and coupled across a width of the slot at a central portion of the slot and at a location close to the edge of the slot without creating a short circuit, respectively, such that influence on frequency band operation associated with the first tunable component does not detrimentally affect frequency band operation associated with the second tunable component, and vice versa.

18. The antenna of claim 17 wherein the first and second dies have two signal paths, with each signal path being associated with one of the multiple bands and wherein the controller selects use of one of the two signal paths according to which band of the multiple bands for which the slot is to be operating, and further wherein each of the two signal paths includes a switch, and wherein the controller is operable to close the switch of each of the two signal paths to configure the slot for operation with a band of the multiple bands that is associated with said each signal path.

19. The antenna of claim 16 wherein the two bands are Ku and Ka bands.

20. A method comprising:
configuring each antenna element of a plurality multi-band radio-frequency (RF) radiating antenna elements to operate at a first band at a first time; and
configuring said each antenna element of a plurality multi-band radio-frequency (RF) radiating antenna elements to operate at a second band at a second time, wherein the first and second bands are different.

21. The antenna of claim 20 further comprising independently controlling first and second resonances of a slot of each of the plurality of multi-band RF radiating antenna elements to obtain operation of the plurality of multi-band RF radiating antenna elements at each of the first and second bands.
